(19) United States
(12) Patent Application Publication
(10) Pub. No.: US 2017/0094753 A1
(43) Pub. Date: Mar. 30, 2017

(54) Light Fixtures with Integrated Control

(71) Applicant: COOPER TECHNOLOGIES COMPANY, Houston, TX (US)

(72) Inventors: Michael Alan Lunn, Peachtree City, GA (US); Brian Eugene Elwell, Tyrone, GA (US)

(73) Assignee: COOPER TECHNOLOGIES COMPANY, Houston, TX (US)

(21) Appl. No.: 15/281,667

(22) Filed: Sep. 30, 2016

Related U.S. Application Data
(60) Provisional application No. 62/234,983, filed on Sep. 30, 2015.

(51) Int. Cl. H05B 37/02

(52) U.S. Cl. CPC H05B 37/0254; H05B 37/0272; H05B 37/0227

(57) ABSTRACT

A light fixture is disclosed herein. The light fixture can include a power supply and at least one light source coupled to the power supply. The light fixture can also include a local controller coupled to the power supply, where the local controller sends at least one first signal to the power supply to control the power supply, where controlling the power supply controls a light output of the at least one light source.

### CROSS-REFERENCE TO RELATED APPLICATIONS

This application claims priority under 35 U.S.C. §119 to U.S. Provisional Patent Application Ser. No. 62/234,983, titled “Light Fixtures With Integrated Control” and filed on Sep. 30, 2015, the entire contents of which are hereby incorporated herein by reference.

### TECHNICAL FIELD

Embodiments described herein relate generally to light fixtures, and more particularly to systems, methods, and devices for light fixtures with integrated control.

### BACKGROUND

Light fixtures are configured as “slaves”. In other words, light fixtures receive commands (e.g., turn on, turn off, adjust light output) and merely respond to those commands. In a system with one or more light fixtures, a central controller is commonly used to generate the commands that control each light fixture. The central controller can also be connected to one or more other devices within a system, including one or more receptacles, one or more wall switches, and a heating, ventilation, and air-conditioning (HVAC) system.

### SUMMARY

In general, in one aspect, the disclosure relates to a light fixture. The light fixture can include a power supply and at least one light source coupled to the power supply. The light fixture can also include a local controller coupled to the power supply, where the local controller sends at least one first signal to the power supply to control the power supply, where controlling the power supply controls a light output of the at least one light source, and where the local controller is independent of an external controller in a lighting system.

In another aspect, the disclosure can generally relate to a lighting system. The lighting system can include a first light fixture, where the first light fixture includes a power supply and at least one light source coupled to the first power supply. The light fixture of the lighting system can also include a first local controller coupled to the first power supply, where the first local controller sends at least one first signal to the first power supply to control the first power supply, where controlling the first power supply controls a first light output of the at least one first light source, and where the first local controller is independent of an external controller in the lighting system.

In yet another aspect, the disclosure can generally relate to local controller integrated with a light fixture. The local controller can include a hardware processor and memory having a number of software instructions, where the software instructions are executed by the hardware processor. The local controller can also include a control engine coupled to the hardware processor and a power supply of the light fixture, where the control engine sends at least one signal to the power supply to control the power supply, where controlling the power supply controls a light output of at least one light source of the light fixture.

These and other aspects, objects, features, and embodiments will be apparent from the following description and the appended claims.

### BRIEF DESCRIPTION OF THE DRAWINGS

The drawings illustrate only example embodiments of light fixtures with integrated control and are therefore not to be considered limiting of its scope, as light fixtures with integrated control may admit to other equally effective embodiments. The elements and features shown in the drawings are not necessarily to scale, emphasis instead being placed upon clearly illustrating the principles of the example embodiments. Additionally, certain dimensions or positionings may be exaggerated to help visually convey such principles. In the drawings, reference numerals designate like or corresponding, but not necessarily identical, elements.

FIG. 1 shows a block diagram of a system that includes light fixtures currently known in the art.

FIG. 2 shows a system diagram of a system that includes light fixtures in accordance with certain example embodiments.

FIG. 3 shows a system diagram that includes a light fixture in accordance with certain example embodiments.

FIG. 4 shows a computing device in accordance with one or more example embodiments.

FIG. 5 shows a system diagram of another system that includes light fixtures in accordance with certain example embodiments.

### DETAILED DESCRIPTION OF EXAMPLE EMBODIMENTS

The example embodiments discussed herein are directed to systems, apparatuses, and methods of light fixtures with integrated control. While example embodiments described herein are directed to use with lighting systems, example embodiments can also be used in systems having other types of devices. Examples of such other systems can include, but are not limited to, security systems, fire protection systems, and emergency management systems. Thus, example embodiments are not limited to use with lighting systems. Similarly, example embodiments can be integrated into other devices aside from light fixtures. Such other devices can include, but are not limited to, a thermostat, a shade control device, an electrical receptacle, and a sensor device.

As described herein, a user can be any person that interacts with light fixtures. Examples of a user may include, but are not limited to, a consumer, an electrician, an engineer, a utility, an electric distribution company, an electrical transmission operator, an instrumentation and control technician, a consultant, a contractor, an operator, and a manufacturer's representative. For any figure shown and described herein, one or more of the components may be omitted, added, repeated, and/or substituted. Accordingly, embodiments shown in a particular figure should not be considered limited to the specific arrangements of components shown in such figure.

Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure. The numbering scheme for the various components in the figures herein is such that each component is a three digit number and corresponding components in other figures have the identical last two digits.

In addition, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments can be used in one or more of any of a number of environments. Examples of such environments can include, but are not limited to, indoor, outdoor, office space, manufacturing, hazardous, marine, humid, corrosive, high temperature, low temperature, parking lot, and dust. Further, the light fixture can be any of a number of types of light fixtures, including but not limited to a floodlight, a recessed light, an emergency egress light, an exit sign, a hi-bay light, an overhead light, a night light, a security light, and a street light.

In certain example embodiments, the light fixtures (or portions thereof) described herein meet one or more of a number of standards, codes, regulations, and/or other requirements established and maintained by one or more entities. Examples of such entities include, but are not limited to, Underwriters' Laboratories (UL), the Institute of Electrical and Electronics Engineers (IEEE), International Electrotechnical Commission (IEC) and the National Fire Protection Association (NFPA). For example, wiring (the wire itself and/or the installation of such wire) that electrically couples to a light fixture may fall within one or more standards set forth in the National Electric Code (NEC). In such a case, the NEC defines Class 1 circuits and Class 2 circuits under various Articles, depending on the application of use.

Example embodiments of light fixtures with integrated control will be described more fully hereinafter with reference to the accompanying drawings, in which example embodiments of light fixtures with integrated control are shown. Light fixtures with integrated control may, however, be embodied in many different forms and should not be construed as limited to the example embodiments set forth herein. Rather, these example embodiments are provided so that this disclosure will be thorough and complete, and will fully convey the scope of light fixtures with integrated control s to those of ordinary skill in the art. Like, but not necessarily the same, elements (also sometimes called components) in the various figures are denoted by like reference numerals for consistency.

Terms such as “first”, “second”, “top”, “bottom”, “side”, “inner”, “outer”, “proximal”, and “distal” are used merely to distinguish one component (or part of a component or state of a component) from another. Such terms are not meant to denote a preference or a particular orientation, and are not meant to limit embodiments of light fixtures with integrated control. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

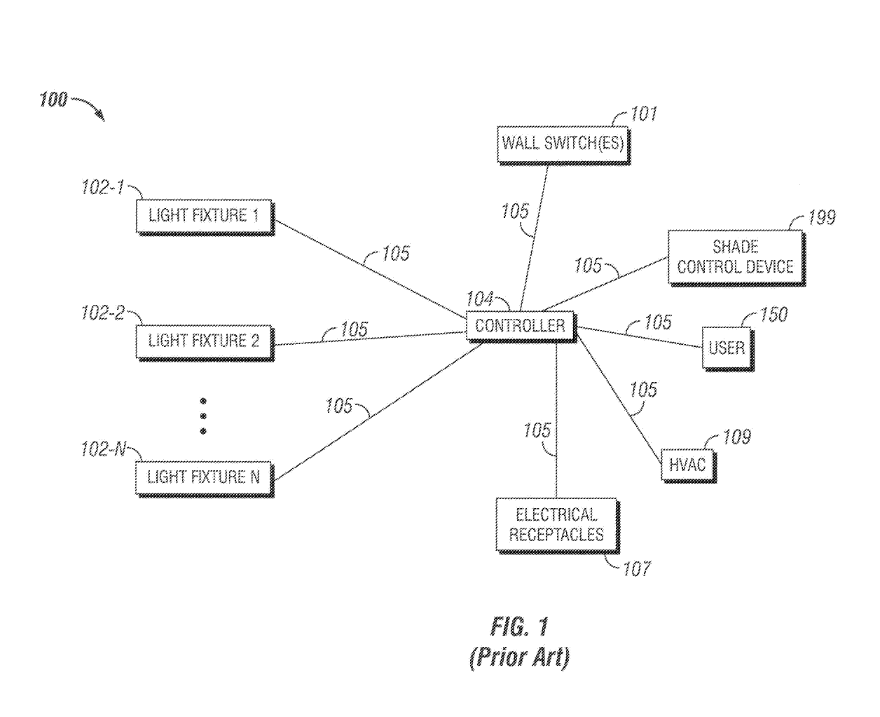

FIG. 1 shows a block diagram of a system 100 that includes light fixtures 102 currently known in the art. The system 100 of FIG. 1 includes a central controller 104, one or more wall switches 101, one or more electrical receptacles 107 (also more simply called receptacles 107), a HVAC unit 109, a shade control device 199, and a number of light fixtures (e.g., light fixture 102-1, light fixture 102-2, light fixture 102-N). The system 100 can also include a user 150, substantially similar to the user defined above. The controller 104 is connected (in this case directly) to each of the other devices in the system 100 and to the user 150 using communication links 105. In some cases, the controller 104 can be called by other names, such as a coordinator in the context of ZigBee-based communication protocols.

Each communication link 105 can include wired (e.g., Class 1 electrical cables, Class 2 electrical cables, electrical connectors) and/or wireless (e.g., Wi-Fi, visible light communication, cellular networking, ZigBee, Bluetooth, WirelessHART, ISA100. Power Line Carrier, RS485, DALI) technology. For example, a communication link 105 can be (or include) one or more electrical conductors that are coupled to light fixture 102-2. A communication link 105 can transmit signals (e.g., communication signals, control signals, power signals, data) between the controller 104 and the user 150 and the other devices of the system 100.

As stated above, with the configuration of the system 100 currently used in the art, each of the light fixtures 102 (in this case, light fixture 102-1, light fixture 102-2, light fixture 102-N) has no control capabilities, as these capabilities reside with the controller 104. Further, the light fixtures 102 of the system 100 do not communicate directly with other devices in the system (100). Instead, the controller 104 controls all communication with devices in the system 100. The same holds true for the electrical receptacles 107, the HVAC system 109, the shade control device 199, and the wall switches 101. The system 100 can include one or more other types of devices, which also lack localized control and do not communicate with other devices of the system 100 aside from the controller 104.

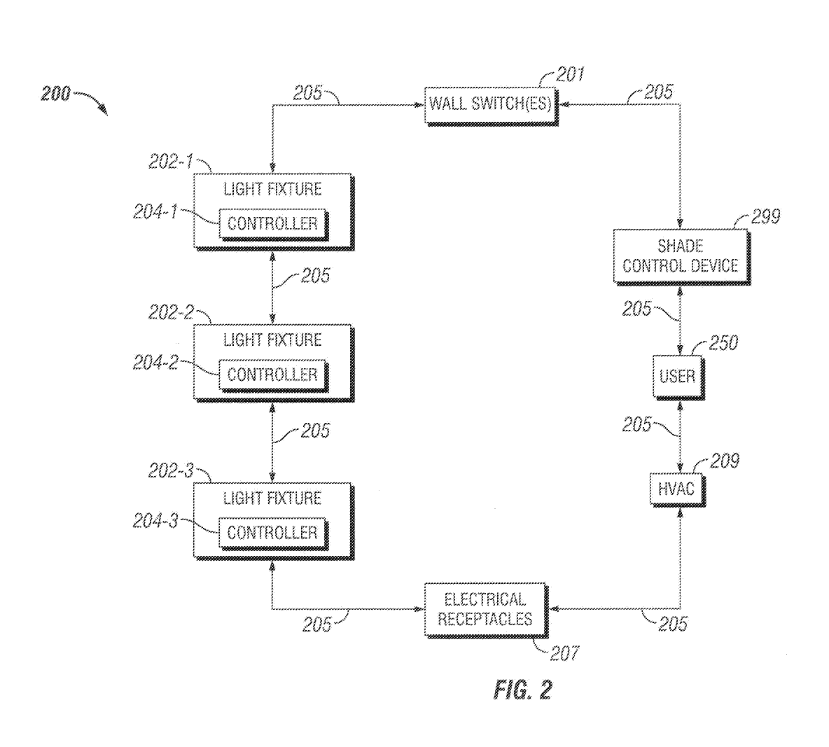

FIG. 2 shows a diagram of a system 200 that includes light fixtures in accordance with certain example embodiments. The system 200 of FIG. 2 includes three light fixtures 202 (light fixture 202-1, light fixture 202-2, and light fixture 202-3), two wall switches 201 (wall switch 201-1, wall switch 201-2), an electrical receptacle 207, a HVAC unit 209, and a shade control device 299. The components of the system 200 of FIG. 2 are substantially the same as the corresponding components of the system 100 of FIG. 1, except as described below. Specifically, each light fixture 202 in the system 200 of FIG. 2 includes its own localized controller 204. In other words, light fixture 202-1 includes controller 204-1, light fixture 202-2 includes controller 204-2, and light fixture 202-3 includes controller 204-3. All of these devices of the system 200 are coupled to each other, directly or indirectly, using communication links 205.

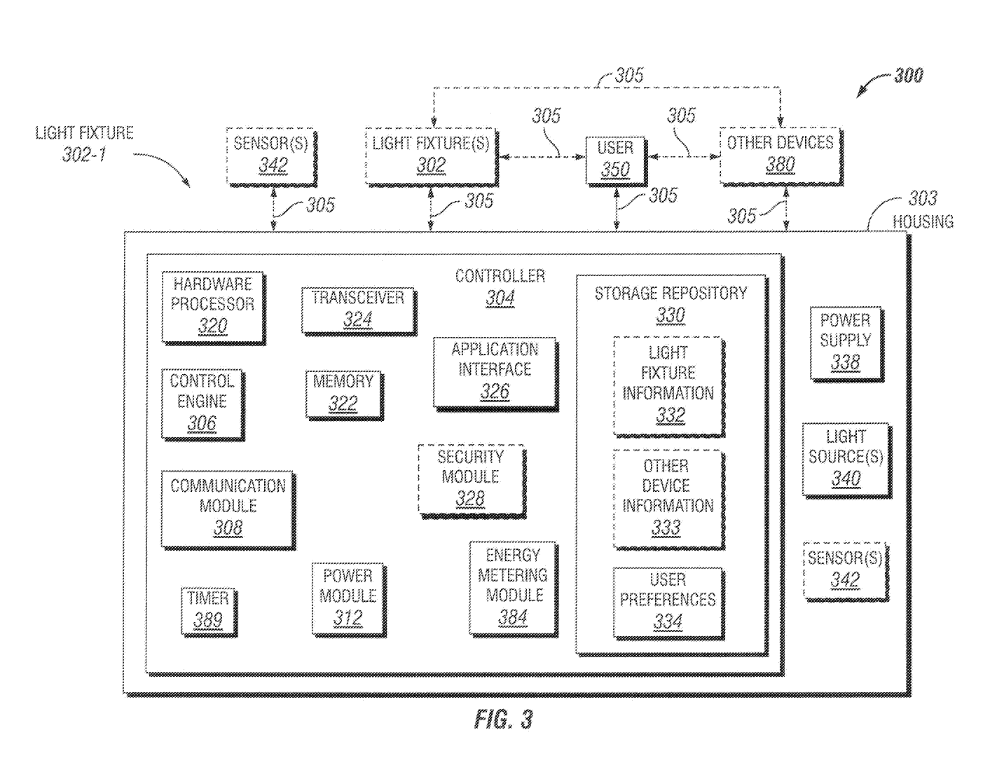

Referring to FIGS. 1 and 2, the system 200 of FIG. 2 has no central controller, as with controller 104 of FIG. 1. Instead, as explained in more detail below with respect to FIG. 3, each light fixture 202 (light fixture 202-1, light fixture 202-2, and light fixture 202-3) in the system 200 of FIG. 2 includes its own localized controller 204 (controller 204-1, controller 204-2, and controller 204-3, respectively). Each of these localized controllers 204 can be configured to perform some or all of the functions that can be performed by the central controller 104 in the system 100 of FIG. 1.

In other words, each localized controller 204 can perform any of a number of functions. Examples of such functions can include, but are not limited to, reading sensor data, controlling a power supply of the corresponding light fixture 202, sending information to other components in the system 200, controlling one or more other components in the system 200, and sending/receiving instructions with another local controller 204. In some cases, one or more other devices (e.g., HVAC unit 209, wall switch 201, electrical receptacle 207, shade control device 299) in the system 200 can also include its own localized controller 204 (not shown).

FIG. 3 shows a system diagram that includes a light fixture 302-1 in accordance with certain example embodiments. In addition to the light fixture 302-1, the system 300 of FIG. 3 can include one or more optional additional light fixtures 302, a user 350, one or more optional other devices 380, and one or more optional sensors 342. The light fixture 302-1 can include a controller 3014, a power supply 338, at least one light source 340, and one or more of the optional sensors 342. The controller 304 can include one or more of a number of components. Such components, can include, but are not limited to, a control engine 306, a communication module 308, a timer 389, a power module 312, an energy metering module 384, a storage repository 330, a hardware processor 320, a memory 322, a transceiver 324, an application interface 326, and, optionally, a security module 328. The components shown in FIG. 3 are not exhaustive, and in some embodiments, one or more of the components shown in FIG. 3 may not be included in an example light fixture 302-1. Any component of the example light fixture 302-1 can be discrete or combined with one or more other components of the light fixture 302-1.

The user 350 is the same as a user defined above. The user 350 interacts with (e.g., sends data to, receives data from) the controller 304 of the light fixture 302-1 via the application interface 326 (described below). The user 350 can also interact with one or more other devices 380, one or more sensors 342, and/or one or more light fixtures 302. Interaction between the user 350 and the light fixture 302-1, the other devices 380, and the light fixtures 302 can be conducted using communication links 305. The communication links 305 can transmit signals (e.g., communication signals, control signals, data) between the light fixture 302-1 and the user 350, one or more of the other devices 380, one or more sensors 342, and/or one or more of the light fixtures 302.

The other devices 380 can be any type of device. Examples of other device can include, but are not limited to, an electrical receptacle, a HVAC system, a wall switch, and a shade control device. A device 380 can communicate with the user 350 and/or light fixture 302-1 using one or more communication links 305. In such a case, the devices 380 (or system thereof) can use one or more of a number of communication protocols.

A light fixture (e.g., light fixture 302, light fixture 302-1) can be a single light fixture (also called a light module), a grouping of light fixtures, or any other suitable source of light. Each light fixture can use one or more of a number of communication protocols. A light fixture (e.g., light fixture 302-1) and or other devices 380 can include and/or be coupled to one or more sensors 342. In some cases, one or more sensors 342 can be included with and/or coupled to a device 380. These sensors 342 can measure one or more parameters in and/or around the light fixture 302. Examples of such parameters can include, but are not limited to, a level of ambient light, a temperature, and the presence of a person. Examples of a sensor 342 can include, but are not limited to, a photocell, an infrared light detector, a thermometer, and an acoustic detector.

In some cases, a sensor 342 can send a parameter, in addition to or in the alternative of measuring a parameter. For example, if a sensor 342 is an indicator light (e.g., a LED), then the sensor 342 can emit a light to indicate a status of the light fixture 302-1 or some other condition. As a specific example, the sensor 342 can emit a green light when the light fixture 302-1 is operating normally, a white light when the controller 304 has received a signal (e.g., adjust a dimming level) from the user 350, and a red light when one or more components of the light fixture 302-1 has failed.

A light source 340 of a light fixture (e.g., light fixture 302-1) can be any source of light that is controllable (e.g., turn on, turn off, dim, adjust the hue, adjust the value, adjust the saturation). A light source 340 can receive power, control, and/or communication signals from a power supply 338. A light source 340 can also emit light based on the signals received from the power supply 338. A light source 340 can use any of a number of lighting technologies, including but not limited to light-emitting diode (LED), incandescent, fluorescent, halogen, sodium vapor, and mercury vapor. If a light source 340 is a LED, the light source can emit any one or more of a number of colors, including but not limited to white, blue, red, and green.

The power supply 338 of a light fixture (e.g., light fixture 302-1) can send power, control, and/or communication signals to a light source 340. Examples of a power supply 338 can include, but are not limited to, a driver and a ballast. The power supply 338 can be a source of independent power generation. For example, the power supply 338 can include an energy storage device (e.g., a battery, a supercapacitor). As another example, the power supply 338 can include photovoltaic solar panels. In addition, or in the alternative, the power supply 338 can receive power from an independent power supply. The independent power supply can be any source of power that is independent of the power supply 338. Examples of the power supply 338 can include, but are not limited to, an energy storage device, a feed to a building, a feed from a circuit panel, and an independent generation source (e.g., photovoltaic panels, a heat exchanger).

In certain example embodiments, the power supply 338 sends power, control, and/or communication signals to, and receives power, control, and/or communication signals from, the controller 304 of the light fixture 302. In this way, the controller 304 of the light fixture 302 controls the power supply 338 (and, thus, the light output of the light sources 340) of the light fixture 302.

The controller 304 of a light fixture (e.g., light fixture 302-1) can interact (e.g., periodically, continually, randomly) with another light fixture 302, a sensor 342, the user 350, and/or other devices 380. The user 350, the sensors 342, the devices 380, and/or the light fixtures 302 can interact with the controller 304 of the light fixture 302-1 using the application interface 326 and the communication links 305 in accordance with one or more example embodiments. Specifically, the application interface 326 of the controller 304 receives data (e.g., information, communications, instructions) from and sends data (e.g., information, communications, instructions) to the user 350, the sensors 342, the other devices 380, and/or the other light fixtures 302.

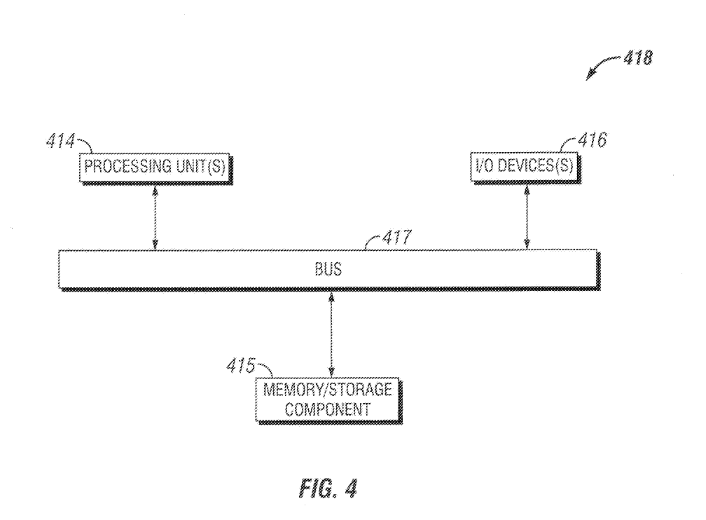

The controller 304, the user 350, the sensors 342, the devices 380, and/or the light fixtures (e.g., light fixture 302-1, light fixture 302) can use their own system or share a system in certain example embodiments. Such a system can be, or contain a form of, an Internet-based or an intranet-based computer system that is capable of communicating with various software. A computer system includes any type of computing device and/or communication device, including but not limited to the controller 304. Examples of such a system can include, but are not limited to, a desktop computer with LAN, WAN, Internet or intranet access, a laptop computer with LAN, WAN, Internet or intranet access, a smart phone, a server, a server farm, an android device (or equivalent), a tablet, smartphones, and a personal digital assistant (PDA). Such a system can correspond to a computer system as described below with regard to FIG. 4.

Further, as discussed above, such a system can have corresponding software (e.g., user software, light fixture software, controller software, sensor software, device software). The software can execute on the same or a separate device (e.g. a server, mainframe, desktop personal computer (PC), laptop, personal desktop assistant (PDA), television, cable box, satellite box, kiosk, telephone, mobile phone, or other computing devices) and can be coupled by the communication network (e.g., Internet, Intranet, Extranet, Local Area Network (LAN), Wide Area Network (WAN), or other network communication methods) and/or communication channels, with wire and/or wireless segments according to some example embodiments. The software of one system can be a part of, or operate separately but in conjunction with, the software of another system within the system 300.

The light fixture 302-1 can include a housing 303. The housing 303 can include at least one wall that forms a cavity. The housing 303 of the light fixture 302-1 can be used to house one or more components (e.g., power supply 338, sensors 342, controller 304) of the light fixture 302-1, including one or more components of the controller 304. For example, as shown in FIG. 3, the controller 304 (which in this case includes the control engine 306, the communication module 308, the storage repository 330, the hardware processor 320, the memory 322, the transceiver 324, the application interface 326, and the optional security module 328) can be disposed within the cavity formed by the housing 303. In alternative embodiments, any one or more of these or other components of the light fixture 302-1 can be disposed on the housing 303 and/or remotely from the housing 303.

The storage repository 330 can be a persistent storage device (or set of devices) that stores software and data used to assist the controller 304 in communicating with the user 350, one or more sensors 342, one or more other devices 380, and one or more other light fixtures 302 within the system 300. In one or more example embodiments, the storage repository 330 stores optional light fixture information 332, optional other device information 333, and user preferences 334. The light fixture information 332 can be any information associated with a light fixture, including light fixture 302-1. Such information can include, but is not limited to, color capability of a light fixture, dimming capability of a light fixture, manufacturer's information of a light fixture, age of a light fixture, hours of operation of a light fixture, communication protocols of a light fixture, physical location of a light fixture, current light output of a light fixture, and orientation of a light fixture.

The other device information 333 can be any information associated with a device 380 and/or a sensor 342. Such information can include, but is not limited to, a type of sensor 342 or device 380, measurements taken and/or functions performed by a sensor 342 or device 380, physical location of a sensor 342 or device 380, manufacturer of a sensor 342 or device 380, manufacturer's information of a sensor 342 or device 380, age of a sensor 342 or device 380, hours of operation of a sensor 342 or device 380, and communication protocols of a sensor 342 or device 380. The user preferences 334 can be any data associated the preferences of a particular user 350.

The storage repository 330 can also store other types of data. Examples of such other types of data can include, but are not limited to, measurements taken by the energy metering module 384, threshold values, algorithms, results of previously run or calculated algorithms, and previous communications with other components (e.g., sensor devices 342, other devices 380) in the system 300. Such data can be any type of data, including but not limited to historical data, calculated data, forecasted data, comparison data, and actual data. Any data stored in the storage repository 330 can be associated with some measurement of time derived from, for example, the timer 389.

Examples of a storage repository 330 can include, but are not limited to, a database (or a number of databases), a file system, a hard drive, flash memory, some other form of solid state data storage, or any suitable combination thereof. The storage repository 330 can be located on multiple physical machines, each storing all or a portion of the light fixture information 332, other device information 333, and/or the user preferences 334 according to some example embodiments. Each storage unit or device can be physically located in the same or in a different geographic location.

The storage repository 330 can be operatively connected to the control engine 306. In one or more example embodiments, the control engine 306 includes functionality to communicate with the user 350, the sensors 342, the other devices 380, and the other light fixtures 302 in the system 300. More specifically, the control engine 306 sends information to and/or receives information from the storage repository 330 in order to communicate with the user 350, the sensors 342, the other devices 380, and the other light fixtures 302. As discussed below, the storage repository 330 can also be operatively connected to the communication module 308 in certain example embodiments.

In certain example embodiments, the control engine 306 of the controller 304 controls the operation of one or more components (e.g., the communication module 308, the timer 389, the transceiver 324) of the controller 304. For example, the control engine 306 can put the communication module 308 in “sleep” mode when there are no communications between the controller 304 and another component (e.g., a light fixture 302, the user 350) in the system 300 or when communications between the controller 304 and another component in the system 300 follow a regular pattern. In such a case, power consumed by the controller 304 is conserved by only enabling the communication module 308 when the communication module 308 is needed.

As another example, the control engine 306 can acquire the current time using the timer 389. The timer 389 can enable the controller 304 to control the power supply 338 (and so also the light sources 340) of the light fixture 302-1, even when the controller 304 has no communication with an external controller (or any of the other devices 380). In certain example embodiments, the timer 389 can track the amount of time that the light sources 340 is operating. In such a case, the control engine 306 can control the power supply 338 (and so also the light sources 340) based on an amount of time measured by the timer 389.

In certain example embodiments, the control engine 306 can analyze data stored in the storage repository 330 using one or more algorithms stored in the storage repository 330. In this way, the control engine 306 can provide a historical analysis and/or a predictive analysis to a user regarding the light fixture 302-1, another light fixture 302, and/or some other device 380 in the system 300. In such a case, for example, the control engine 306 can establish a preventative maintenance program for the light fixture 302-1, including any specific components (e.g., the power supply 338, a light source 340, a sensor 342) thereof.

The control engine 306 can provide control, communication, and/or other similar signals to the user 350, one or more sensors 342, one or more of the other devices 380, and one or more of the other light fixtures 302. Similarly, the control engine 306 can receive control, communication, and/or other similar signals from the user 350, one or more of the other devices 380, and one or more of the light fixtures 302. The control engine 306 can control each light fixture 302 automatically (for example, based on one or more algorithms stored in the control engine 306) and/or based on control, communication, and/or other similar signals received from a controller of another component of the system 300 through the communication links 305. The control engine 306 may include a printed circuit board, upon which the hardware processor 320 and/or one or more discrete components of the controller 304 can be positioned.

In certain example embodiments, the control engine 306 can include an interface that enables the control engine 306 to communicate with one or more components (e.g., communication module 308) of the light fixture 302-1 and/or another component (e.g., another light fixture 302) of the system 300. For example, if the power supply 338 for the light fixture 302-1 operates under IEC Standard 62386, then the power supply 338 can include a digital addressable lighting interface (DALI). In such a case, the control engine 306 can also include a DALI to enable communication with the power supply 338 within the light fixture 302-1. Such an interface can operate in conjunction with, or independently of, the communication protocols used to communicate between the controller 304 and the user 350, the other devices 380, the sensors 342, and the other light fixtures 302.

The control engine 306 can operate in real time. In other words, the control engine 306 of the controller 304 can process, send, and/or receive communications with the user 350 and/or other controllers of other devices 380, other light fixtures 302, and sensors 342 as any changes (e.g., discrete, continuous) occur within the system. Further, the control engine 306 of the controller 304 can, at substantially the same time, control the light fixture 302, a sensor 342, another light fixture 302, and/or another device 380 based on such changes. In addition, the control engine 306 of the controller 304 can perform one or more of its functions continuously. For example, the controller 304 can continuously communicate light fixture information 332 and/or other device information 333. As another example, the controller 304 can continuously control the power supply 338 of the light fixture 302-1. In such a case, any updates or changes to such information (e.g., a change in ambient lighting detected by a sensor 342) can be used by the controller 304 in adjusting an output (e.g., current) sent by the power supply 338 to a light source 340.

In certain example embodiments, the control engine 306 of the controller 304 can operate (e.g., in real time) based on demand response signals received from a user (e.g., a utility, a homeowner). Further, the control engine 306 (or other portion of the controller 304) can include a measurement module (not shown) that monitors and captures the power (e.g., current) used by the light fixture 302-1, one or more of the sensors 342, another device 380, and/or another light fixture 302. In addition, the control engine 306 (or other portion of the controller 304) can include a timer (not shown). In such a case, the timer can measure one or more elements of time, including but not limited to clock time and periods of time. The timer can also include a calendar in addition to clock functions.

The control engine 306 (or other components of the controller 304) can also include one or more hardware and/or software architecture components to perform its functions. Such components can include, but are not limited to, a universal asynchronous receiver/transmitter (UART), a universal synchronous receiver/transmitter (USRT), a serial peripheral interface (SPI), a direct-attached capacity (DAC) storage device, an analog-to-digital converter, an inter-integrated circuit (I²C), and a pulse width modulator (PWM).

In certain example embodiments, the communication module 308 of the controller 304 determines and implements the communication protocol (e.g., from the light fixture information 332 and the other device information 333 of the storage repository 330) that is used when the control engine 306 communicates with (e.g., sends signals to, receives signals from) the user 350, one or more of the sensors 342, one or more of the other devices 380, and/or one or more of the other light fixtures 302. In some cases, the communication module 308 accesses the light fixture information 332 and/or the other device information 333 to determine which communication protocol is within the capability of the recipient of a communication sent by the control engine 306. In addition, the communication module 308 can interpret the communication protocol of a communication received by the controller 304 so that the control engine 306 can interpret the communication.

The communication module 308 can send data directly to and/or retrieve data directly from the storage repository 330. Alternatively, the control engine 306 can facilitate the transfer of data between the communication module 308 and the storage repository 330. The communication module 308 can also provide encryption to data that is sent by the controller 304 and decryption to data that is received by the controller 304. The communication module 308 can also provide one or more of a number of other services with respect to data sent from and received by the controller 304. Such services can include, but are not limited to, data packet routing information and procedures to follow in the event of data interruption.

The timer 389 of the controller 304 can track clock time, intervals of time, an amount of time, and/or any other measure of time. The timer 389 can also count the number of occurrences of an event, whether with or without respect to time. Alternatively, the control engine 306 can perform the counting function. The timer 389 is able to track multiple time measurements concurrently. The timer 389 can track time periods based on an instruction received from the control engine 306, based on an instruction received from the user 350, based on an instruction programmed in the software for the controller 304, based on some other condition or from some other component, or from any combination thereof.

The timer 389 can be configured to track time when there is no power delivered to the controller 304 (e.g., the power module 312 malfunctions) using, for example, a super capacitor or a battery backup. In such a case, when there is a resumption of power delivery to the controller 304, the timer 389 can communicate any aspect of time to the controller 304. In such a case, the timer 389 can include one or more of a number of components (e.g., a super capacitor, an integrated circuit) to perform these functions.

The energy metering module 384 of the controller 304 measures one or more components of power (e.g., current, voltage, resistance, VARs, watts) associated with the light fixture 302-1 at one or more points in the system 300. The energy metering module 384 can include any of a number of measuring devices and related devices, including but not limited to a voltmeter, an ammeter, a power meter, an ohmmeter, a current transformer, a potential transformer, and electrical wiring. The energy metering module 384 can measure a component of power continuously, periodically, based on the occurrence of an event, based on a command received from the control engine 306, based on measurements captured by the sensors 342, and/or based on some other factor.

The power module 312 of the controller 304 provides power to one or more other components (e.g., timer 389, control engine 306) of the controller 304. In certain example embodiments, the power module 312 receives power from the power supply 338. The power module 312 can include one or more of a number of single or multiple discrete components (e.g., transistor, diode, resistor), and/or a microprocessor. The power module 312 may include a printed circuit board, upon which the microprocessor and/or one or more discrete components are positioned. In some cases, the power module 312 can include one or more components that allow the power module 312 to measure one or more elements of power (e.g., voltage, current) that is delivered to and/or sent from the power module 312,

The power module 312 can include one or more components (e.g., a transformer, a diode bridge, an inverter, a converter) that receives power (for example, through an electrical cable) from a source (e.g., the power supply 338) and generates power of a type (e.g., alternating current, direct current) and level (e.g., 12V, 24V, 470V) that can be used by the other components of the controller 304. The power module 312 can use a closed control loop to maintain a preconfigured voltage or current with a tight tolerance at the output. The power module 312 can also protect the rest of the electronics (e.g., hardware processor 320, transceiver 324) from surges generated in the line. In addition, or in the alternative, the power module 312 can be a source of power in itself to provide signals to the other components of the controller 304. For example, the power module 312 can be a battery. As another example, the power module 312 can be a localized photovoltaic power system.

The hardware processor 320 of the controller 304 executes software in accordance with one or more example embodiments. Specifically, the hardware processor 320 can execute software on the control engine 306 or any other portion of the controller 304, as well as software used by the user 350, one or more of the sensors, one or more of the other devices 380, and/or one or more of the other light fixtures 302. The hardware processor 320 can be an integrated circuit, a central processing unit, a multi-core processing chip, a multi-chip module including multiple multi-core processing chips, or other hardware processor in one or more example embodiments. The hardware processor 320 is known by other names, including but not limited to a computer processor, a microprocessor, and a multi-core processor.

In one or more example embodiments, the hardware processor 320 executes software instructions stored in memory 322. The memory 322 includes one or more cache memories, main memory, and/or any other suitable type of memory. The memory 322 is discretely located within the controller 304 relative to the hardware processor 320 according to some example embodiments. In certain configurations, the memory 322 can be integrated with the hardware processor 320.

In certain example embodiments, the controller 304 does not include a hardware processor 320. In such a case, the controller 304 can include, as an example, one or more field programmable gate arrays (FPGAs), one or more insulated-gate bipolar transistors (IGBTs), and/or one or more integrated circuits (ICs). Using FPGAs, IGBTs, ICs, and/or other similar devices known in the art allows the controller 304 (or portions thereof) to be programmable and function according to certain logic rules and thresholds without the use of a hardware processor. Alternatively. FPGAs, IGBTs, ICs, and/or similar devices can be used in conjunction with one or more hardware processors 520.

The transceiver 324 of the controller 304 can send and/or receive control and/or communication signals. Specifically, the transceiver 324 can be used to transfer data between the controller 304 and the user 350, the sensors 342, the other devices 380, and/or the other light fixtures 302. The transceiver 324 can use wired and/or wireless technology. The transceiver 324 can be configured in such a way that the control and/or communication signals sent and/or received by the transceiver 324 can be received and/or sent by another transceiver that is part of the user 350, the sensors, the other devices 380, and/or the other light fixtures 302.

When the transceiver 324 uses wireless technology as the communication link 305, any type of wireless technology can be used by the transceiver 324 in sending and receiving signals. Such wireless technology can include, but is not limited to, Wi-Fi, visible light communication, cellular networking, and Bluetooth. The transceiver 324 can use one or more of any number of suitable communication protocols (e.g., ISA100. HART) when sending and/or receiving signals. Such communication protocols can be dictated by the communication module 308. Further, any transceiver information for the user 350, the sensors 342, the other devices 380, and/or the other light fixtures 302 can be stored in the storage repository 330.

Optionally, in one or more example embodiments, the security module 328 secures interactions between the controller 304, the user 350, the other devices 380, and/or the light fixtures 302. More specifically, the security module 328 authenticates communication from software based on security keys verifying the identity of the source of the communication. For example, user software may be associated with a security key enabling the software of the user 350 to interact with the controller 304, the other devices 380, and/or the light fixtures 302. Further, the security module 328 can restrict receipt of information, requests for information, and/or access to information in some example embodiments.

By using example light fixtures 302 with local controllers 304 described herein, the system 300 can have distributed intelligence that works more efficiently and effectively than by having a single central controller, as shown in the system 100 of FIG. 1 above. As an example, if a sensor 342 of a light fixture 302-1 detects occupancy, the controller 304 of the light fixture 302-1 can instruct the HVAC unit (a device 380) to set a temperature of 72° F. in the space where the occupancy is detected. Subsequently, when the sensor 342 of the light fixture 302-1 no longer detects occupancy in the space, the controller 304 of the light fixture 302-1 can instruct the HVAC unit to set a temperature of 78° F. in the space.

Further, example embodiments can work “out of the box”, without a user 350 having to input information, adjust settings, or otherwise manipulate the controller 304 of the light fixture 302 before or during installation of the light fixture 302. In such a case, an example controller 304 can have fixed settings that cannot be altered by a user 350, but that may be altered by the control engine 306 over time based on, for example, historical data and the results of one or more algorithms stored in the storage repository 330. Alternatively, an example controller 304, while having default settings, can be altered by a user 350 so that the controller 304 operates according to the specifications of the user 350. In any event, one such “out of the box” setting of the controller 304 can be auto-commissioning the light fixture 302-1 and at least one other component (e.g., one or more of other light fixtures 302, one or more other devices 380) when the system 300 (or portion thereof) is completing installation.

One or more of the functions performed by any of the components of an example light fixture (e.g., controller 304) can be performed using a computing device 418. An example of a computing device 418 is shown in FIG. 4. The computing device 418 implements one or more of the various techniques described herein, and which is representative, in whole or in part, of the elements described herein pursuant to certain example embodiments. Computing device 418 is one example of a computing device and is not intended to suggest any limitation as to scope of use or functionality of the computing device and/or its possible architectures. Neither should computing device 418 be interpreted as having any dependency or requirement relating to any one or combination of components illustrated in the example computing device 418.

Computing device 418 includes one or more processors or processing units 414, one or more memory/storage components 415, one or more input/output (I/O) devices 416, and a bus 417 that allows the various components and devices to communicate with one another. Bus 417 represents one or more of any of several types of bus structures, including a memory bus or memory controller, a peripheral bus, an accelerated graphics port, and a processor or local bus using any of a variety of bus architectures. Bus 417 includes wired and/or wireless buses.

Memory/storage component 415 represents one or more computer storage media. Memory/storage component 415 includes volatile media (such as random access memory (RAM)) and/or nonvolatile media (such as read only memory (ROM), flash memory, optical disks, magnetic disks, and so forth). Memory/storage component 415 includes fixed media (e.g., RAM, ROM, a fixed hard drive, etc.) as well as removable media (e.g., a Flash memory drive, a removable hard drive, an optical disk, and so forth).

One or more I/O devices 416 allow a customer, utility, or other user to enter commands and information to computing device 418, and also allow information to be presented to the customer, utility, or other user and/or other components or devices. Examples of input devices include, but are not limited to, a keyboard, a cursor control device (e.g., a mouse), a microphone, and a scanner. Examples of output devices include, but are not limited to, a display device (e.g. a monitor or projector), speakers, a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 418 is connected to a network (not shown) (e.g., a local area network (LAN), a wide area network (WAN) such as the Internet, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 418 includes at least the minimal processing, input, and/or output means necessary to practice one or more embodiments.

Further, those skilled in the art will appreciate that one or more elements of the aforementioned computer device 418 is located at a remote location and connected to the other elements over a network in certain example embodiments. Further, one or more embodiments is implemented on a distributed system having one or more nodes, where each portion of the implementation (e.g., controller 304) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

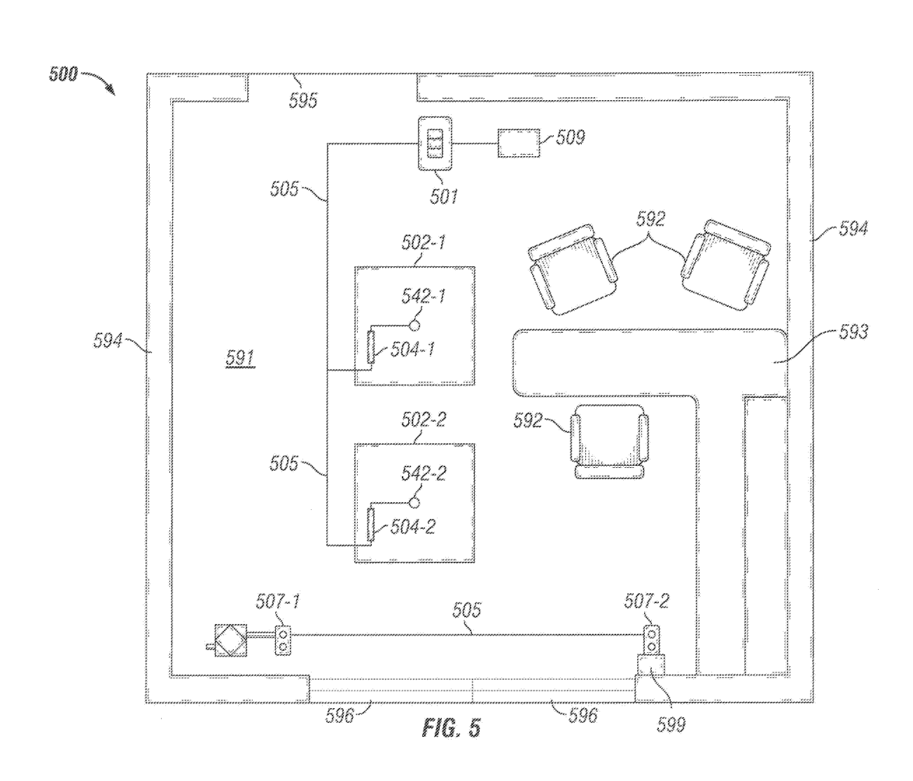

FIG. 5 shows a system diagram of another system 500 that includes light fixtures 502 in accordance with certain example embodiments. Specifically, referring to FIGS. 1-5, the system 500 includes a room (defined by walls 594, a doorway 595, and windows 596) the forms a space 591. Within the space 591 are three chairs 592 and a table 592. Also within the space 591 are two light fixtures 502 (light fixture 502-1 and light fixture 502-2), two electrical receptacles 507 (electrical receptacle 507-1 and electrical receptacle 507-2), a wall switch 501, a thermostat 509 that controls a HVAC unit, and a shade control device 599. Light fixture 502-1 includes a local controller 504-1 and a sensor 542-1, and light fixture 502-2 includes a local controller 504-2 and a sensor 542-2.

When the room is not occupied, one or both of the controllers 504 can stop power from flowing to the electrical receptacles 507, have the shade control device 599 close the blinds that cover the windows 596, adjust the setting on the thermostat 509 to a setting of 78° F., and turn off the light sources of the light fixtures 502. When someone enters the space 591, the sensor 342-1 of light fixture 502-1 will send a signal to the controller 504-1 of light fixture 502-1. As a result, the controller 504-1 can instruct the power supply of light fixture 502-1 to provide a certain amount of power to the light source of light fixture 502-1 so that the light source emits light.

Further, controller 504-1 can instruct controller 504-2 of light fixture 502-2 to instruct the power supply of light fixture 502-2 to provide a certain amount of power to the light source of light fixture 502-2 so that the light source emits light. Similarly, controller 504-2 can instruct controller 504-1 of light fixture 502-1 to instruct the power supply of light fixture 502-1 to provide a certain amount of power to the light source of light fixture 502-1 so that the light source emits light. In addition, controller 504-1 and/or controller 504-2 can instruct the shade control device 599 open the blinds that cover the windows 596. Further, controller 504-1 and/or controller 504-2 can adjust the thermostat 509 to a setting of 72° F. In addition, controller 504-1 and/or controller 504-2 can allow power to flow (as by closing a breaker switch) to the electrical receptacles 507.

Controller 504-1 and/or controller 504-2 can also receive and manage the components of the system 500 based on inputs received from a user. For example, if an occupant of the space 591 further adjusts the thermostat 509, controller 504-1 and/or controller 504-2 can instruct the shade control device 599 further adjust the blinds that cover the windows 596. As another example, if a utility (e.g., a distribution company, a transmission operator, a generator) sends a demand response signal to reduce the power consumed in the space 591 by 10%, controller 504-1 and/or controller 504-2 can reduce the light output by the light fixture 502-1 by 10%, shut off the HVAC unit for 2 minutes, send an email to the user about the demand response signal and the resulting actions, and post a message on the display of the thermostat 509 to inform the occupants of the space 591 as to what is occurring and why.

Example embodiments provide a number of benefits. Examples of such benefits include, but are not limited to, little or no set up required; more simplistic installation, replacement, modification, and maintenance of a light fixture; improved aesthetics; improved electrical and operational efficiency; compliance with one or more applicable standards and/or regulations; lower maintenance costs, increased flexibility in system design and implementation; and reduced cost of labor and materials. Example embodiments can be used for installations of new electrical devices (e.g., light fixtures) and/or new sensor devices. Example embodiments can also be integrated (e.g., retrofitted) with existing electrical devices and/or sensor devices.

Although embodiments described herein are made with reference to example embodiments, it should be appreciated by those skilled in the art that various modifications are well within the scope and spirit of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A light fixture, comprising:
a power supply;
at least one light source coupled to the power supply; and
a local controller coupled to the power supply, wherein the local controller sends at least one first signal to the power supply to control the power supply, wherein controlling the power supply controls a light output of the at least one light source, and wherein the local controller is independent of an external controller in a lighting system.

2. The light fixture of claim 1, wherein the local controller is configured to communicate with the external controller of the lighting system, wherein the local controller sends at least one second signal to the external controller based on the at least one first signal.

3. The light fixture of claim 2, wherein the additional device comprises at least one selected from a group consisting of an additional light fixture, a heating/ventilation/air conditioning unit, an electrical receptacle, a shade control device, and a wall switch.

4. The light fixture of claim 1, wherein the at least one first signal is based on default settings.

5. The light fixture of claim 1, further comprising:
at least one sensor coupled to the local controller, wherein the at least one sensor measures at least one parameter, wherein the at least one first signal is based, in part, on the at least one parameter measured by the at least one sensor.

6. The light fixture of claim 5, wherein the local controller is configured to send at least one second signal to the external controller, wherein the at least one second signal is based on the at least one parameter measured by the at least one sensor.

7. The light fixture of claim 1, wherein the local controller controls the power supply on a continuous basis.

8. The light fixture of claim 1, wherein the at least one first signal is based, in part, on a demand response signal received by the local controller from a user.

9. A lighting system comprising:
a first light fixture comprising:
a first power supply;
at least one first light source coupled to the first power supply; and
a first local controller coupled to the first power supply, wherein the first local controller sends at least one first signal to the first power supply to control the first power supply, wherein controlling the first power supply controls a first light output of the at least one first light source, and wherein the first local controller is independent of an external controller in the lighting system.

10. The lighting system of claim 9, wherein the first light fixture further comprises at least one first sensor coupled to the first local controller, wherein the at least one first sensor measures at least one first parameter, wherein the at least one first signal is based, in part, in the at least one first parameter measured by the at least one first sensor.

11. The lighting system of claim 9, further comprising:
an electrical device coupled to the first local controller, wherein the electrical device receives at least one second signal from the first local controller, wherein the at least one second signal controls the electrical device.

12. The lighting system of claim 11, wherein the electrical device is an electrical receptacle, and wherein the at least one second signal prevents power from flowing to an outlet of the electrical receptacle.

13. The lighting system of claim 9, further comprising:
a second light fixture device coupled to the first controller, wherein the second light fixture comprises:
a second power supply;
at least one second light source coupled to the second power supply; and
a second local controller coupled to the second power supply, wherein the second local controller sends at least one second signal to the second power supply to control the second power supply, wherein controlling the second power supply controls a second light output of the at least one second light source, and wherein the second local controller is independent of the external controller in the lighting system.

14. The lighting system of claim 13, wherein the second local controller further sends the at least one second signal to the first local controller.

15. The lighting system of claim 13, wherein the second local controller receives the at least one first signal sent by the first local controller.

16. The lighting system of claim 15, wherein the at least one first signal is used by the second local controller to generate the at least one second signal.

17. The lighting system of claim 13, wherein the second light fixture further comprises at least one second sensor coupled to the second controller, wherein the at least one second sensor measures at least one second parameter, wherein the at least one second signal is based, in part, in the at least one second parameter measured by the at least one second sensor.

18. A local controller integrated with a light fixture, the controller comprising:
a hardware processor;
memory comprising a plurality of software instructions, wherein the plurality of software instructions are executed by the hardware processor; and
a control engine coupled to the hardware processor and a power supply of the light fixture, wherein the control engine sends at least one signal to the power supply to control the power supply, wherein controlling the power supply controls a light output of at least one light source of the light fixture.

19. The local controller of claim 18, further comprising:
a transceiver coupled to the control engine, wherein the transceiver is configured to transfer at least one second signal with a user.

20. The local controller of claim 19, wherein the at least one second signal is sent by the user to alter a setting of the control engine.
